(19) United States
(12) Patent Application Publication
(10) Pub. No.: US 2006/0259359 A1
(43) Pub. Date: Nov. 16, 2006

(54) Method of monetizing networks

(76) Inventor: Edward D. Gogel, Henderson, NV (US)

Correspondence Address: LAW OFFICES OF BARRY N. YOUNG, 260 SHERIDAN AVENUE, SUITE 410, PALO ALTO, CA, 94306-2047, US

(21) Appl. No.: 11/130,297

(22) Filed: May 16, 2005

(51) Int. Cl. G06Q 30/00

(52) U.S. Cl. 705/14

(57) ABSTRACT

A business model and method for monetizing a wireless network and for providing incentives to expand the network is based upon a shared advertising revenue model. Users are given free, subsidized or reduced fee access to the network in return for receiving directed advertising that may be localized and/or personalized to the user. Advertisers may establish advertising rules that provide a variety of different criteria that designate how and when advertising content is to be presented to the user. Criteria comprise demographics, including user interests, location, time of day, or data content requested by a user. Advertising revenue from advertisers whose advertising content is presented to users is shared among network entities providers of access points.

### BACKGROUND OF THE INVENTION

This invention relates generally to methods and systems for creating and distributing incentives, such as revenue, to providers, operators, users and advertisers to promote utilization and expansion of networks, especially wireless networks. More particularly, the invention is directed to methods and systems based upon a shared advertising revenue business model for producing and distributing revenue streams among wireless network providers, users and advertisers to encourage the establishment, growth and utilization of wireless networks.

With the wide acceptance of the I.E.E.E. 802.11 wireless network (“Wi-Fi”) standard and the availability of relatively inexpensive Wi-Fi equipment and devices, wireless networks are appearing in many different venues. These include homes, business establishments such as coffee shops and hotels, as well as public facilities such as libraries and airports. Some cities have even begun to establish Wi-Fi access points or “hot spots” in downtown areas. There are typically two types of wireless network providers, those that provide the Wi-Fi service as a free benefit to users, such as business establishments seeking to attract customers or visitors to public areas typically to support local establishments, or those that charge a one-time or longer term subscription fee to users for access to the wireless network. While these approaches have enjoyed some success and the expansion of Wi-Fi networks will undoubtedly continue, the current approaches suffer from several disadvantages that may slow or in some cases inhibit the proliferation of Wi-Fi networks. Although the costs for establishing and operating a Wi-Fi network are not great, these costs are not insignificant. In some cases, it may be difficult to determine the direct benefit to a provider of free wireless network services, which may have a tendency to reduce the incentive to provide such services. In other cases, users of wireless networks may not have an easy way of identifying or connecting to networks that they can immediately use, and may not have an easy way to roam between networks, often requiring subscriptions from multiple providers. This is inconvenient and could have the effect of discouraging proliferation of Wi-Fi networks.

Another problem with existing networks, both wireless and wired, that are based upon an advertising revenue model to attract new providers and subscribers as sources of revenue is that advertisers do not have a convenient way to localize and personalize their messages to potential customers. There is no practical way, for example, for small businesses to target their message to users within a predetermined locale or area, or based upon user demographics or other relevant criteria. The typical key word-based advertising that is currently prevalent is unsuited and too expensive for businesses interested in targeting a specific locale or a specific type of customer, and this market of potential advertisers is largely untapped. For example, a restaurant in an airport might wish to have their advertisement displayed to wireless network users only during certain hours of the day and only within a particular airport terminal. Similarly, advertisers on wired networks do not have a convenient way of localizing and personalizing their advertising to users. Many businesses would be willing to pay premium rates for targeted personalized and localized advertising which currently is unavailable with key word-based advertising models employed on internet search engines, and this potential advertising revenue stream has gone largely untapped.

It is desirable to provide methods and systems which avoid the foregoing and other problems with existing networks, and it is to these ends that the present invention is directed.

### SUMMARY OF THE INVENTION

The invention avoids the foregoing and other problems of existing networks by providing methods that are based upon a new business model for operating and monetizing networks in a way that provides incentives that encourage the growth and establishment of networks, particularly wireless networks, and which afford the localized and/or personalized targeted advertising that has been substantially unavailable to advertisers. The invention enables advertisers to focus and direct their advertising for the greatest return, which enables network operators to charge premium advertising rates. The invention also opens up the advertising market to many small business advertisers that otherwise would not find it economical or practical to advertise on conventional networks.

More particularly, the invention employs a shared advertising revenue approach that provides monetary incentives to network entities to establish and expand networks and local access points, and to afford free, subsidized, or reduced fee access to users without the need for a subscription or access fee. The invention not only encourages providers to establish and expand network access points by allowing them to share in a portion of advertising revenue for advertising presented to users through their associated access points, it also encourages expansion of the user base since users may have free unrestricted access.

In one aspect, the invention provides methods of operating a network that includes providers of access point having predetermined locations and advertisers with associated advertising content. Advertising content from one or more of the advertisers is presented to a user accessing the network based upon associated rules for presenting the content, and advertising revenue from the advertisers is shared with a provider of the access point by which the user accesses the network.

In another aspect, providers and locations of access points, users, and advertisers are registered. User information is collected; and advertising content and associated rules for presenting the content are stored. Advertising content from one or more advertisers is selected based upon the rules for presentation to a user accessing the network by an access point, and advertising revenue from the advertisers is shared with the access point provider.

In other aspects, the advertising content that is presented to the user is either personalized to the user, or localized to the user or the access point, or both. More particularly, the advertising content is personalized based either upon information about the user, data requests made by the user to a content provider, or the data returned to the user in response to data requests.

In still other more specific aspects, in addition to sharing advertising revenue with providers of access points, the invention provides incentives to network entities such as providers, users and advertisers for referring new entities that become registered on the network. Referral codes that are unique to each such entity are used to identify the referring entity and to track incentives to the entity.

Other aspects of the invention will become apparent from the detailed description below.

### BRIEF DESCRIPTION OF THE DRAWINGS

FIG. 1 is a diagrammatic view of a portion of a data network of the type on which the invention may be employed, the figure showing the business relationships among network entities that commonly exist on such known networks;

FIG. 2 is a diagrammatic view of the network of FIG. 1 that illustrates the newly enabled and expanded business relationships and enhanced incentives afforded by the invention;

FIG. 3 is a diagrammatic view that illustrates a registration process in accordance with the invention for the functional entities of the network of FIG. 2;

FIG. 4 is a diagrammatic view which illustrates a model of an incentive revenue sharing process afforded by the invention;

FIG. 5 is a diagrammatic view which illustrates a provider incentive compensation process in accordance with the invention;

FIG. 6 is a diagrammatic view which illustrates a user incentive compensation process in accordance with the invention;

FIG. 7 is a diagrammatic view that illustrates an advertising process in accordance with the invention;

FIG. 8 is a flow chart illustrating a client authentication process in accordance with the invention;

FIG. 9 is a diagrammatic view illustrating the operation of client software for advertising substitution or insertion processes in accordance with the invention;

FIG. 10 is a diagrammatic view illustrating the operation of the client software for integrated advertising in accordance with the invention:

FIG. 11 is an illustration of a conventional browser web page showing an example of inserted advertising;

FIG. 12 illustrates the operation of an advertising processor in substituting new advertising for existing advertising content on a web page in accordance with the invention;

FIG. 13 is an illustration of a web page showing an example of integrated advertising; and

FIG. 14 illustrates an alternative embodiment of the invention in which advertising is inserted into an electronic mail message.

### DESCRIPTION OF PREFERRED EMBODIMENTS

The present invention is directed to business models and methods for operating a network to produce and distribute shared advertising revenue among network advertisers, providers and users that is particularly well adapted to wireless network environments, and will be described in that context. It will become apparent, however, that this is illustrative of only one utility of the invention, and that many aspects of the invention are applicable to wired networks as well.

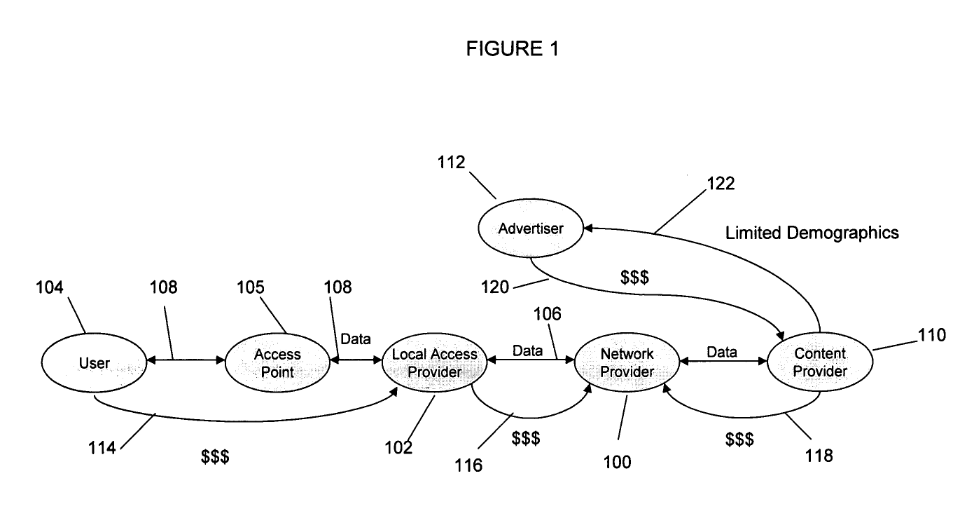

FIG. 1 is a diagrammatic view of a portion of a data network of the type in which the business model and method of the invention may be implemented. FIG. 1 illustrates some of the network entities or members that are commonly present in the network, as well as the business relationships that typically exist currently among such entities. As shown, the network entities may comprise a network provider 100 which provides the physical network layer or infrastructure through which data is transmitted. Network provider 100 may be a telecommunications company such as Quest or MCI that provides the TCP/IP backbone through which network data flows. A plurality of local access providers 102, which may comprise a plurality of physically dispersed connection points to internet service providers (“ISPs”) such as Earthlink, Comcast, etc., provide network access to a plurality of users 104 via a plurality of access points 105. (For simplicity of illustration, only one access provider, access point and user are illustrated in the figure, it being understood that the network may have many such entities.) Each of the plurality of local access providers 102 may provide one or more access points 105 which afford either wired or wireless connections to users 104 for network access. Typically, the connection 106 between local access providers 102 and the network provider 100 is a wired connection, although it need not be. In the case of a wireless network, the access points provided by local access provider 102 may be implemented using conventional Wi-Fi devices, and the data connections 108 between users and the local access points and access providers are wireless connections. This enables mobile users 104 to access the network from a plurality of different physical locations. The network may further comprise a plurality of content providers 110 and a plurality of advertisers 112. Content providers 110 may be web portals such as Google, Yahoo, etc., which respond to data requests from users to provide content as well as advertisements from advertisers 112.

FIG. 1 illustrates the revenue relationships among the various network entities. Users 104 typically pay either a subscription fee or a one-time access fee 114 to a local access provider 102 which, in turn, pays a fee 116 for network access to network provider 100. In the case of wireless networks where local access providers 102 provide Wi-Fi access points 105 for mobile users, network access may be free to the user, as in the case of commercial amenity sites which provide free access to attract customers to other goods and services, or to community sites, such as cities, which provide free access to benefit local downtown establishments, for instance. In cases of free access, there would be no fee 114 paid by the user to the local access provider. In other cases, such as in airports or other public commercial facilities, the user may be required to pay either a subscription fee or a one-time access fee to the local access provider. Content provider 110 similarly pays a fee 1 18 to network provider 100 to host the content provider on the network, and advertisers 112 pay fees 120 to content providers for distributing their advertising content to users. Typically, fees 120 may be “click-through” fees paid on the basis of either the number of users which actually click on an advertisement or the number of users to which the advertisement is displayed. Generally, the content providers furnish to the advertisers either only limited or no demographics, as indicated at 122, with regard to end users. Accordingly, most advertisers tend to be national advertisers, and may only provide more directed and localized advertisement in response to user data requests for specific information on local facilities of the national advertiser.

As it is apparent from the business model relationships shown in FIG. 1, the network is supported primarily by fees paid by the various network entities for access to the network. Local access providers that provide free access to users in order to attract users to their locale typically do so simply as a cost of doing business, and expect to cover their costs through the sales of other goods and services. Due to the costs of establishing and maintaining wireless access points, however, and the difficulty in measuring a direct return on investment, many commercial establishments may not have the incentive to establish wireless access points and to offer free access to customers. Similarly, there exists a whole class of advertisers for which the model illustrated in FIG. 1 is not attractive. These advertisers comprise, for example, small businesses which operate in localized areas such as neighborhoods, local shopping districts, or in limited geographical regions, and which derive little or no benefit from the broader based advertising that characterizes the network of FIG. 1. For these advertisers key word-based advertising is ineffective, and they typically do not advertise on networks. Accordingly, they represent a large class of potential advertisers from whom significant advertising revenue is being missed.

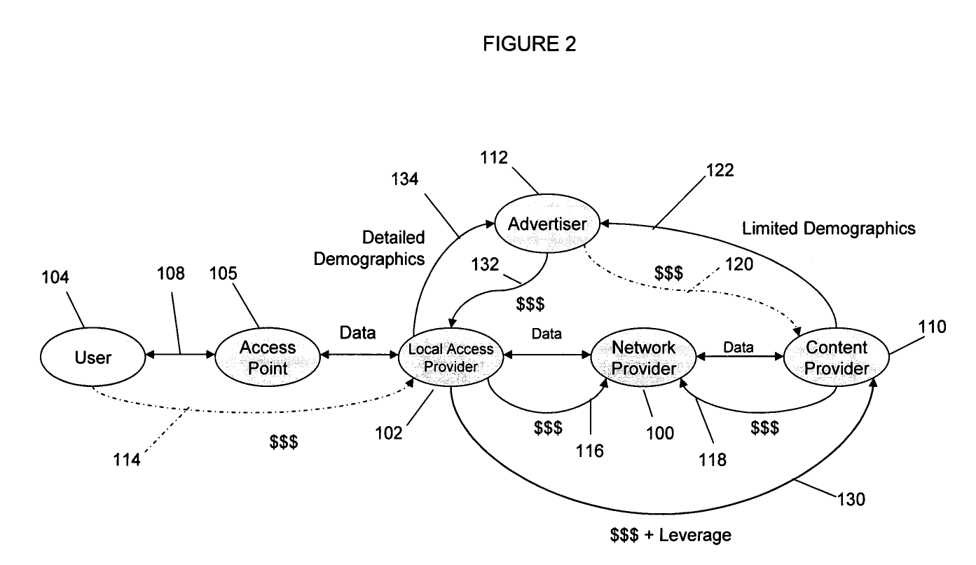

FIG. 2 shows the network of FIG. 1 implementing the business model and method of the invention, and illustrates the newly-enabled business relationships among the network entities afforded by the invention which enable greater monetization of the network. In particular, FIG. 2 illustrates a shared advertising revenue model that can substantially reduce or eliminate some of the conventional revenue flows between the network entities, such as the fees 114 paid by users to local access providers and the click-through revenue 120 paid by advertisers to content providers. Instead, the invention enables local access providers 102 to monetize their network access points by providing leverage 130 against a content provider 110 and offers users 104 an advertising-based method of subsidizing their free access through payments 132 directly from advertiser 112 to a local access provider 102. As will be described in more detail shortly, by providing detailed demographics 134 and other relevant information to advertisers 112, local access providers 102 enable advertisers to target and focus their advertising so that it may be either localized to an area or personalized to a user, or both. This substantially expands the market base of potential advertisers 112 to encompass many small business concerns for which the more broad-based advertising offered by the network may have been unattractive and too expensive with conventional network advertising models. Instead, the invention enables local access providers to establish business relationships with a large number of small business advertisers 112 and to charge premium advertising rates 132 to such advertisers. This allows the advertisers to reduce the click-through fees 120 paid to content providers 110 while allowing local access providers to increase their leverage with the content providers. Users 104 benefit because they are able to gain free access to the network. Moreover, the invention provides incentives to local access providers 102 to expand the network by establishing and operating more access points to attract additional users and advertisers, since this can increase their advertising revenue. Furthermore, as the number of users increases, local access providers gain greater leverage with content providers, since by being able to provide more localized and personalized directed advertising they are able to demand a portion of the advertising revenues received by content providers. In some cases, users may prefer not to be exposed to advertising. Accordingly, as an alternative to free access such users may be offered a fee-based account in which they pay for access either through a subscription fee or a one-time access fee.

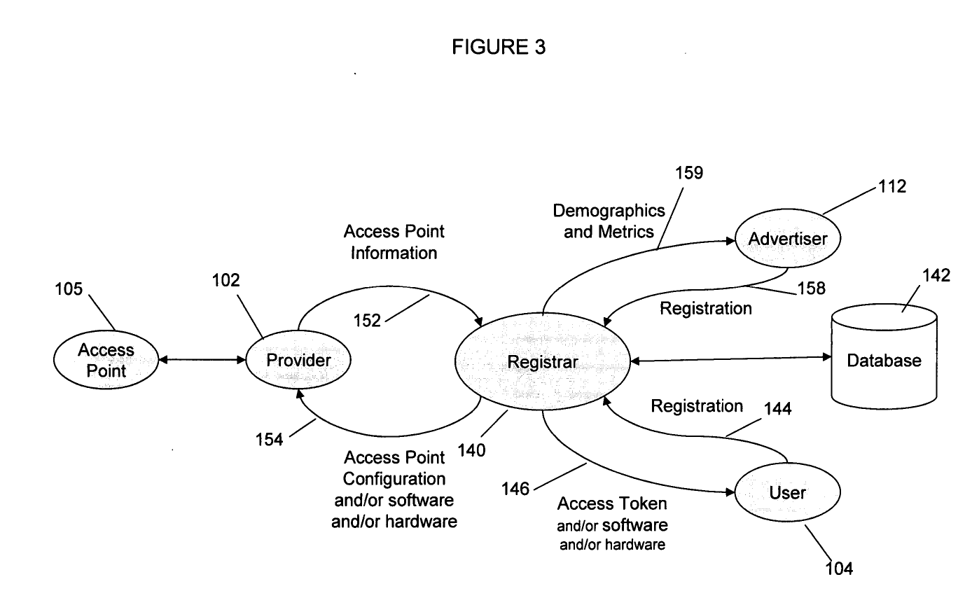

In order to best realize many of the advantages of the invention, it is desirable to obtain certain information about various ones of the network entities, and to use this information in providing localized and/or personalized advertising. FIG. 3 illustrates a registration process in accordance with the invention as a preferred way in which information about the various network entities may be obtained and stored for later use by the invention. As shown in FIG. 3, the invention may employ a registrar 140 comprising an entity with which the various network entities register and which collects and stores information about the network entities in a database 142, for example. Registering entities may be given a unique referral code to identify the entity and for use in tracking incentives to the entity, as will be described. The functions of registrar 140 may be performed by one of the network entities described previously, or by another entity such as a network provider, or it may be a function distributed among various ones of the network entities.

Users 104 may register, as shown at 144, with the registrar 140 by providing certain user demographic information, such as name, address, age, areas of interest, and other information that would be relevant to advertisers. Additionally, users may provide information on the methods by which they desire to share in revenue payments if they choose to receive incentives for signing up additional advertisers, providers or users. These revenue payments may be used to purchase goods and services from network entities, for example. If the registering user has previously been furnished with a referral code from another user or a provider, the user may supply this code to the registrar also, and the registrar may use this referral code to identify and provide incentives to the referring entity. The referral code information provided by the user and information tracking incentives to referring entities may be stored by the registrar in database 142. The registrar may also provide the user with an access token, as indicated at 146, which may be used to identify and authenticate the user on the network, and which may include a user-unique referral code to enable tracking incentives to the user for signing up additional advertisers, providers and users.

In addition, the registrar preferably provides the user with client software, as shown at 146, for accessing the network and for managing the information provided to the user. The client software may be downloaded software, pre-installed software in the user's wireless network access device, or a hardware device which incorporates the software and which interfaces with the user's wireless network device. The client software may perform a number of different functions that facilitate user network access and communications, and that manage advertising and revenue sharing. As will be described in more detail below, these include detecting wireless access points or networks which are in range of a user, and identifying whether the detected access points or networks are part of the registrar's network by checking their identities against a database to determine if the access point providers are registered with the registrar. The client software preferably also automatically connects to wireless networks and authenticates the user. Additionally, the software may handle the presentation and/or display of advertisements to the user, as well as communicating the user's referral code to the network to track incentives to the user.

Referring again to FIG. 3, each provider 102 may establish and provide one or more access points 105 by which users access the network (only one access point is shown in the figure). During registration, providers 102 may request the right to provide users access to the registrar's network. The requesting provider may optionally furnish the registrar with a referral code previously furnished to the provider by another, referring, user or provider. The referral code, as described above, may be used by the registrar for identification purposes to track and provide incentive payments to referring users or providers for signing up new providers. During registration, the provider may furnish to the registrar access point information, including, for example, the particular make and model numbers of its network access devices, the physical locations, including country, state, city or other local, and one or more unique identifiers, such as hardware MAC addresses or a service set identifiers (SSID) of its access points. The registrar in response may furnish to the provider at 154 a predetermined set of configuration processes for access point 105 which will enable users to gain network access via the access point. These configuration processes may include a unique key or token which is recognized by the client software provided to a user upon registration. The registrar may also furnish to the provider software or hardware that automatically configures the access point to facilitate user access. Access point configuration may be either a one-time configuration process or may be performed on scheduled intervals where ongoing configuration changes may be desirable. The registrar may additionally furnish the provider with a unique referral code to serve as a mechanism for tracking incentives to the provider for signing up additional advertisers, providers and users. The provider may register additional access points with the registrar as they are added by providing the relevant access point information 152 and configuring the access points 154 as described.

Advertisers 112 wishing to advertise to registered users of the network may also register with the registrar. Where the advertiser was signed-up, i.e., referred, by an already registered user or provider, the advertiser may furnish (at 158) the registrar with the referral code of the referring user or provider, and select a desired method of payment for future incentives. The registrar may provide to the advertiser a unique advertiser identifier, as indicated at 159, which the advertiser may use to access the registrar's system to make advertising purchases, view reports on currently purchased advertising, or to associate advertising rules with purchased advertising.

To facilitate the purchase of advertising by advertisers, the registrar may also furnish an interface which advertisers may use to establish the advertising rules for their purchased advertising. These rules may specify parameters or other criteria or conditions for the selection and presentation of advertising to a user, such as the type, size and placement of advertising, and may be based upon particular criteria or combinations of particular criteria defined by the advertiser. Criteria may comprise detailed user demographics, the context in which the advertising is featured based upon selected user demographics such as age, interests, etc., the location of the user (country, state, city, local, etc.), the date and time periods during which the advertiser wishes to advertise, data requests by the user, and URLs and/or other content being transferred to the user. These advertising rules may be stored by the registrar in database 142 along with the purchased advertising, and the advertising provided to users which satisfy the advertising criteria set out in the rules.

Additionally, advertisers may specify a price they are willing to pay for advertising, and can preferably specify whether advertising will be purchased and paid for on a per-view, per-click, or other some other basis. Advertisers also may provide the actual text of the advertisement, including images, the design and the format of the desired display, which may be stored in the database along with the associated advertising rules.

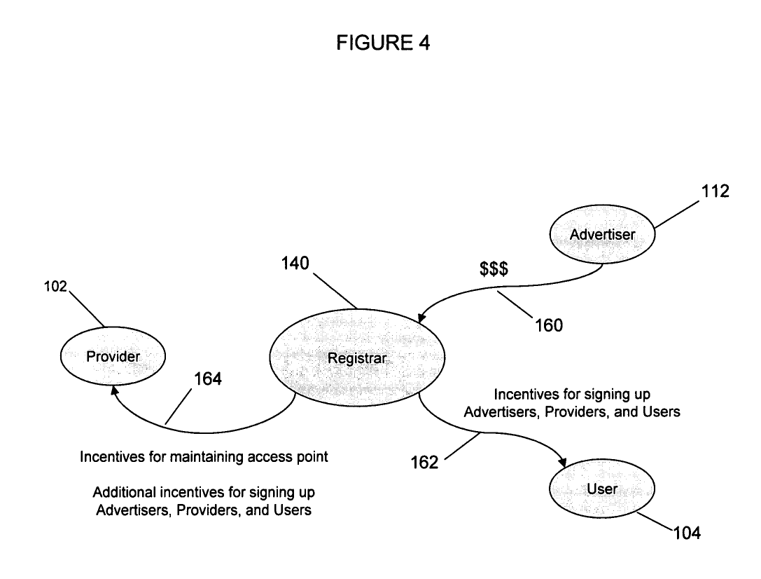

Prior to describing preferred advertising processes of the invention, the overall revenue and compensation models and processes employed by the invention will first be described. As noted previously, the invention has as an objective encouraging the establishment and growth of the network by increasing the numbers of providers, advertisers and users. To encourage this expansion, the invention provides incentives to entities to become members of the network and to sign up others as members. These incentives may take different forms. For instance, users have an incentive to become members of the network because they may obtain free access to the network to the extent that they elect to participate in the advertising process. Alternatively, users may choose to pay a one-time access or subscription fee for access if they do not wish to receive advertising. Incentives in the form of a shared portion of advertising revenue received from advertisers may also be given to network members. FIG. 4 illustrates this overall revenue process.

As shown in FIG. 4, advertisers 112 may pay (160) for the right to place advertising with the users according to advertiser-selected rules and criteria, as indicated above and as will be described in more detail shortly. Users 104 may receive incentives 162, such as a portion of the advertising revenue received by the registrar for the user signing up, i.e., referring, new advertisers, providers and users. As described above, incentives may be tracked through the use of unique referral codes furnished to registered network users. The referral codes may be used by the registrar for accounting purposes to determine the amount of the referral incentives given to the users. Similarly, registered providers 102 may receive incentives (164), such as a share of the overall advertising revenue, by signing up additional advertisers, providers and users, with each provider also being furnished with a unique provider referral code which the registrar may use for accounting purposes. Providers may also receive incentives 164 for establishing and maintaining access points, as indicated in the figure. These incentives may be a percentage of the revenue received from advertisers whose advertising is presented to a user. As will be described shortly, providers also have an additional incentive for establishing access points because the more access points they have, the greater the share of advertising revenue they have an opportunity to receive.

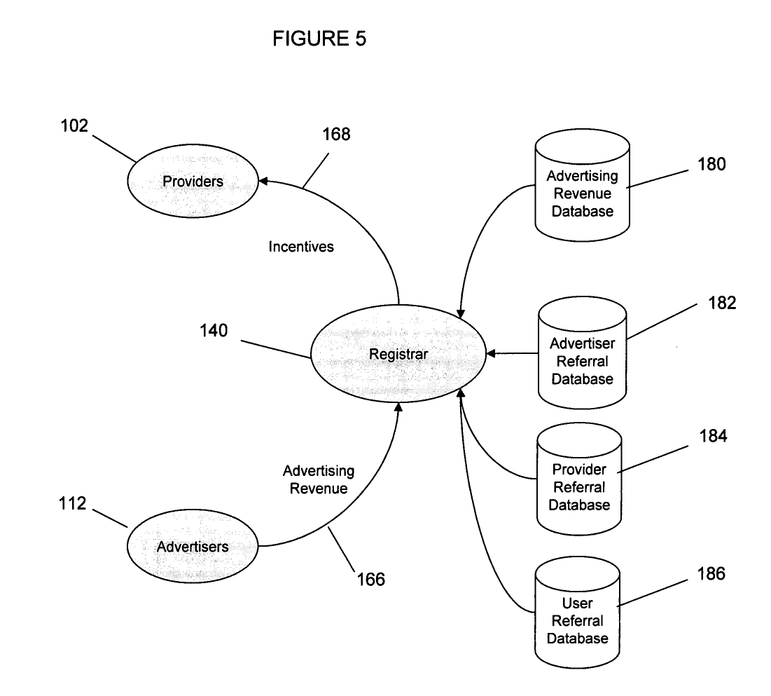

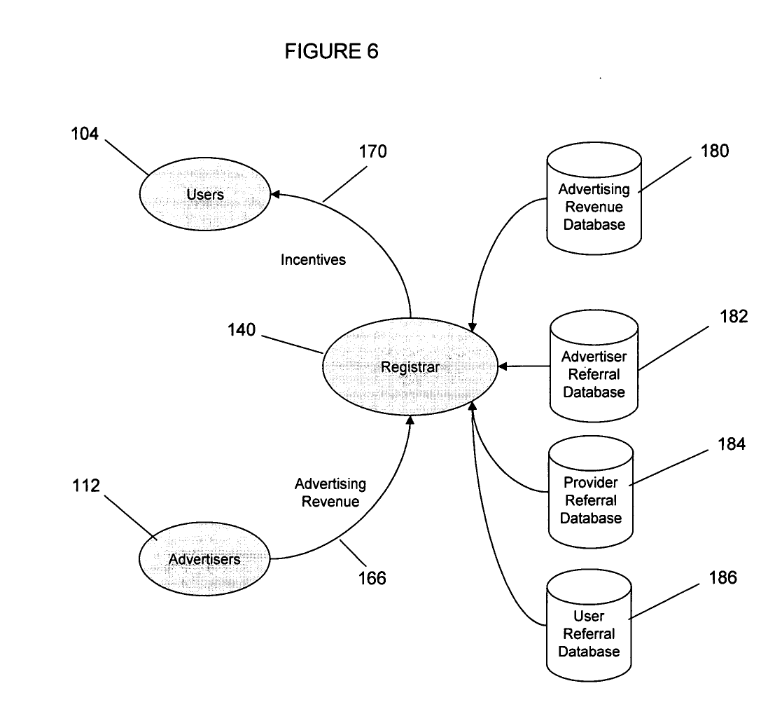

FIGS. 5 and 6 respectively illustrate in more detail the provider and user compensation processes. As shown in the figures, registrar 140 may maintain a database 180 for storing advertising revenue information, a database 182 for advertiser referrals, a database 184 for provider referrals, and a database 186 for user referrals. Although shown as separate databases in FIGS. 5 and 6, databases 180-186 may be combined into one or more databases, or may be contained in database 142 shown in FIG. 3. The information stored in these databases may be used by the registrar for determining provider and user incentives compensation. Advertisers 112 may provide advertising revenue 166 to registrar 140 based upon an advertisement placement model to be described shortly. The registrar may provide as incentives 168 to a provider 102 a percentage of the revenue from advertisements presented to users of the provider's access points. Additionally, as noted above, providers may receive incentives for referring other advertisers, providers and users to the network. Similarly, as illustrated in FIG. 6, users 104 may receive as incentives 170 a percentage of the revenue from advertisers, providers and users which they referred to the registrar's network. Additionally, as described above, another incentive to users is the availability of free network access, which in and of itself may be a significant encouragement to users to refer others to the network since it encourages expansion of access points.

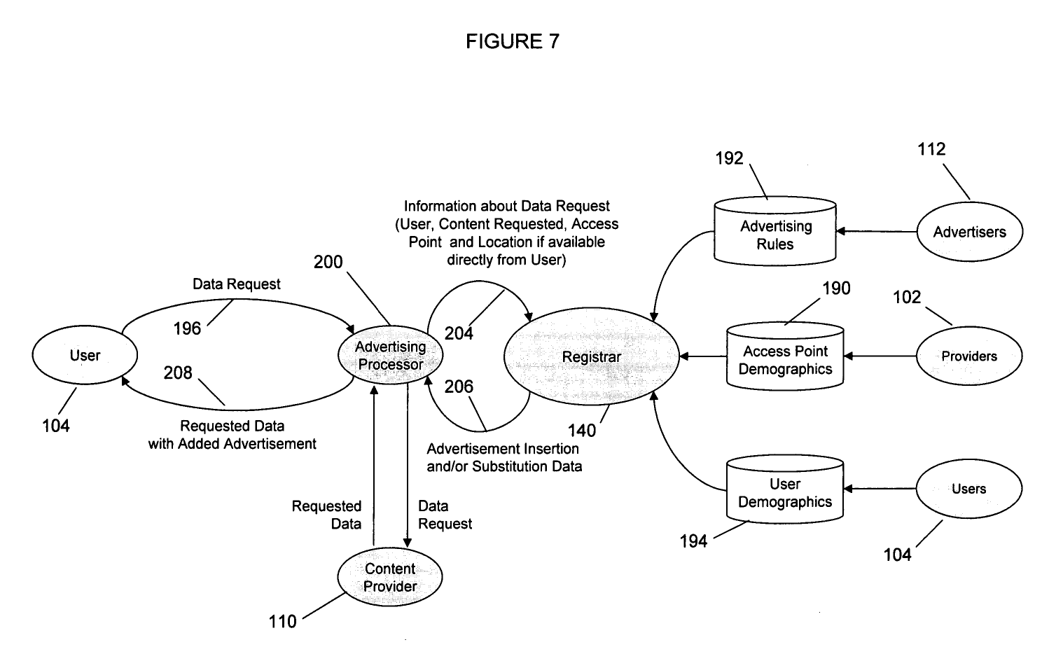

FIG. 7 illustrates a preferred advertisement placement model and process in accordance with the invention. The invention has as one of its principal objectives the placement of advertising with users that is localized to a particular user's location and/or personalized to the user in some manner, e.g., to the user's demographics or interests. The location of the user may be determined by the location of the access point through which the user accesses the network, since access point locations are pre-registered by providers with the registrar as previously described in connection with FIG. 3. This access point information and other demographics relative to the access point may be stored in database 142 (FIG. 3) as previously described. As indicated in FIG. 7, the registrar may use the access point demographics 190 and the advertising rules 192 to place advertisements localized to the region about the access point and relevant to the user 104. Where the user is located between access points, the provider may refine user location by triangulation of signal strengths between the access points and provide refined location information to the registrar. Also, user network devices may incorporate global positioning system (GPS) devices that automatically provide location information to the access provider, and this location information may be used to localize advertising to the user.

Advertisements may be personalized to the user in different ways. First, if the user has previously registered on the network, the user demographics information 194 stored in database 142 (FIG. 3) may be used to obtain specific information about the user and the user's interests which the registrar can use to personalize the advertising. In addition, users accessing the network may request data from the third party content provider 110 by issuing a data request 196, and information about the data request or the data received from the content provider may also be used to personalize advertising to a user.

The access point by which the user accesses the network or the associated access point provider preferably includes an advertising processor 200 which, among other functions, may receive the data request from the user and forward it to the content provider 110, as indicated in FIG. 7. The advertising processor may also provide information about the data request to the registrar as indicated at 204. This information may include information about the content requested by the user which is relevant to the insertion of advertising, and may further include information about the user, such as user identity, and the location of the access point and user. The registrar may use the information from advertising processor 200 and the information stored in databases 190-194 to select and forward advertising insertion or substitution data from one or more advertisers to the advertising processor, as indicated at 206. The advertising processor receives the data requested from the content provider and provides the requested data with the selected added advertising to the user, as indicated at 208.

The advertising processor 200 may be implemented in different ways. It may be integrated directly into a network access point either as hardware or as embedded software that manipulates the network data stream to insert advertisements into the stream or to replace existing advertisements (as will be described) with different advertisements for presentation to the user. The advertising processor may comprise a component in the client software that displays advertisements alongside requested content or that inserts or replaces advertisements within requested content provided to the user applications.

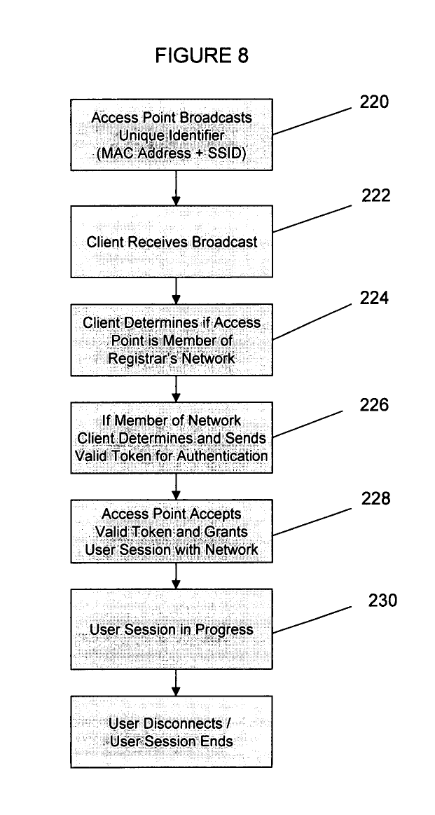

The advertisement placement process may begin with a user signing onto the network. Referring to FIG. 8, each access point may broadcast a unique identifier comprising, for example, a MAC address plus an SSID, as indicated at 220. The client software within a user's device receives the broadcast (at 222) and determines whether the access point is a member of the registrar's network (224). Membership may be determined by a user accessing a database included with the user's client software that lists registered access points. If the detected access point is a member of the network, the client software may send a valid token to authenticate the user (226). The access point accepts the token and grants the user an access session on the network at 228. The client software configures the user in accordance with the configuration specification for the access point, and the user session begins (at 230).

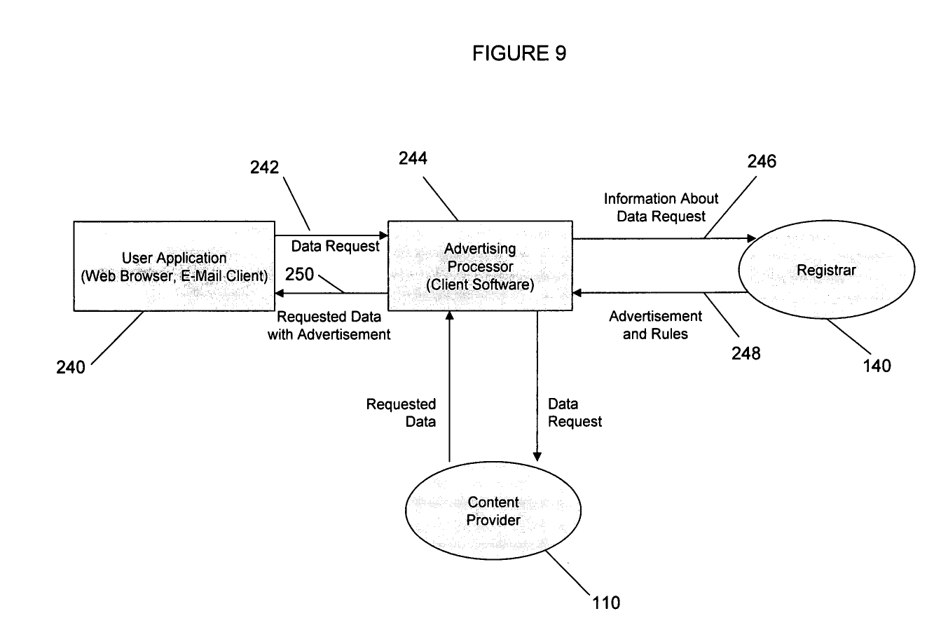

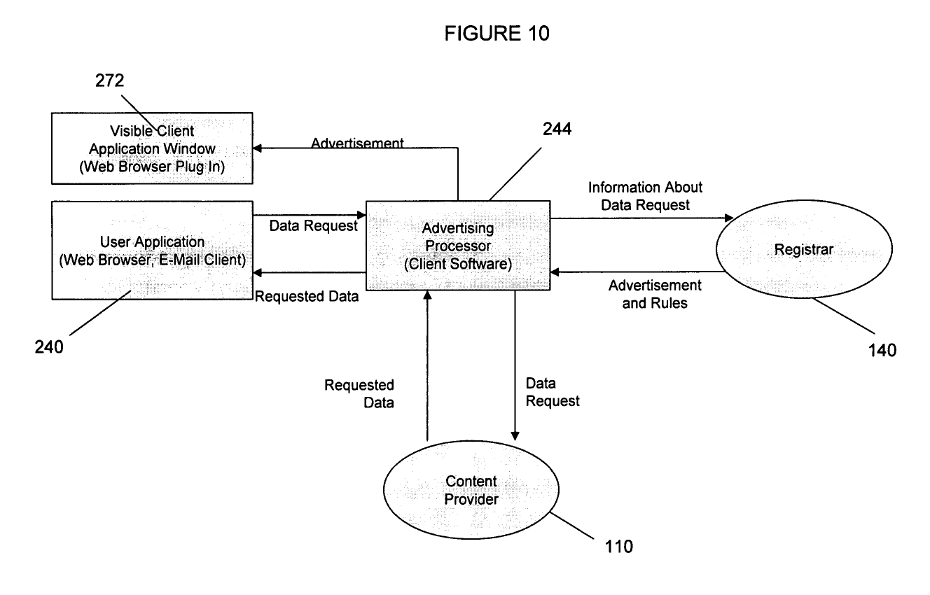

FIGS. 9 and 10 illustrate the advertisement placement process during a user session. FIG. 9 illustrates the substitution of existing advertising contained in content provided to the user with localized and personalized advertising provided by advertiser 112, or insertion of localized and personalized advertisement into the content being provided. FIG. 10 illustrates the integration of advertising into the content being provided to the user.

Referring to FIG. 9, during a session, a user application 240, such as a web browser, an e-mail client, etc., sends a data request 242 to the advertising processor 244 in the client software. As described previously in connection with the FIG. 7, the advertising processor may forward the data request to a third party content provider 110 and receive back from the content provider the requested data. The advertising processor may additionally forward (at 246) information about the data request to the registrar 140. The information, as previously described, includes not only information about the content of the data requested, but may also include information about the user, the access point, and the locations of the user and access point. The registrar, using the rules and demographic information stored in databases 190-194 (FIG. 7), may supply stored localized and/or personalized advertising from one or more advertisers and associated advertising rules back to the advertising processor, as indicated at 248. The advertising processor may combine the advertising with the requested data provided by the content provider and forward the requested data with the advertising to the user application 240, as indicated at 250. The advertising processor may use the advertising rules supplied by the registrar either to insert the localized and/or personalized advertising into the content provided to the user application or to substitute advertising for existing advertising in the content.

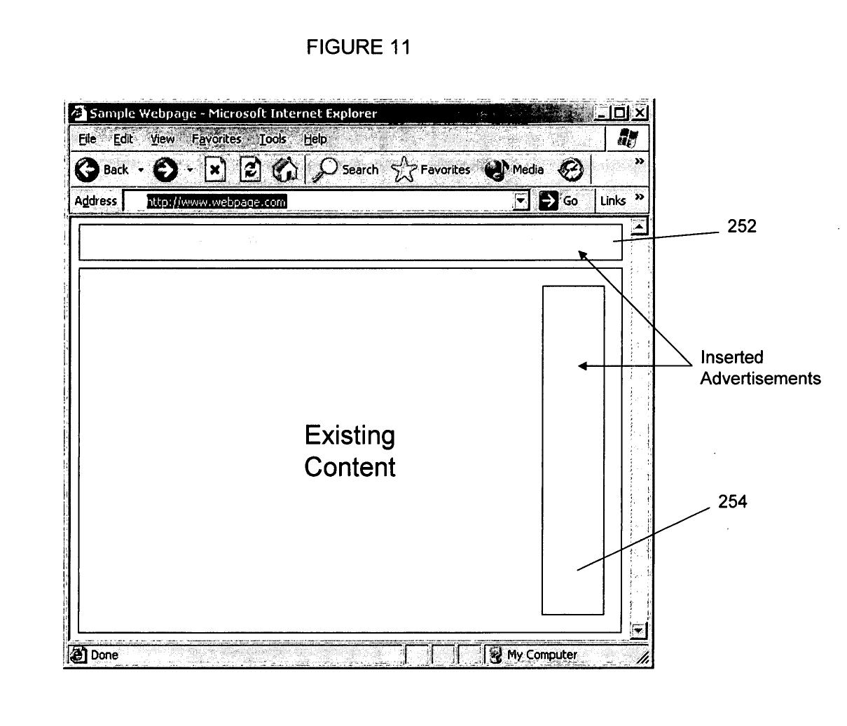

FIG. 11 illustrates a typical web page as may be displayed in a web browser of the user for presenting content, and shows possible locations 252 and 254 on the web page where localized and/or personalized advertising may be inserted. A first location 252 may be an elongated horizontal area across the top of the web page similar to a typical toolbar. A second location 254 may be a vertically extending area adjacent to one side of the web page where advertising is typically placed. Upon the advertising processor receiving a data request from a user, it requests and fetches the requested data from the content provider and determines the formatting rules of the data, e.g., HTML, PDF, GIF, etc. The advertising processor may determine the placement of the advertisement in the displayed content based upon placement guidelines in the rules provided from advertisers, and apply the appropriate formatting rules for the type of data to format and insert the advertising within the guidelines. The advertising processor may also apply other changes to the formatted data to insure that it is still valid to the requester and does not appear to be modified, such as length of data, checksum, CRC, etc.

The advertising processor may apply the logic of the rules in a recursive fashion to insure proper encapsulation and integrity of the data stream. For example, a HTML document is encapsulated in separate TCP/IP packets when flowing through a network. The advertising processor may first need to assemble TCP/IP packets into a full HTML document, insert the advertising, and re-encapsulate the data into new TCP/IP packets for transmission to the user's browser. The changes to the packets in the underlying protocol (TCP/IP) may also be made directly without fully re-encapsulating the data. This could be accomplished, for example, by dynamically changing the specified size of the packets to match the change in length created by the inserted advertising. Error checking and other packet integrity data such as checksum or CRC may also need to be updated before being forwarded to the user.

In an alternative embodiment of the invention, if a user accesses the network for voice communications using a telephone or other voice-over-IP (“VoIP”) device instead of an application that displays content such as a browser or other computer application, advertising content may be presented to the user as an audible or a visual message to the VoIP device. The advertising content may be presented either at the beginning, during or following the user's voice session, for example.

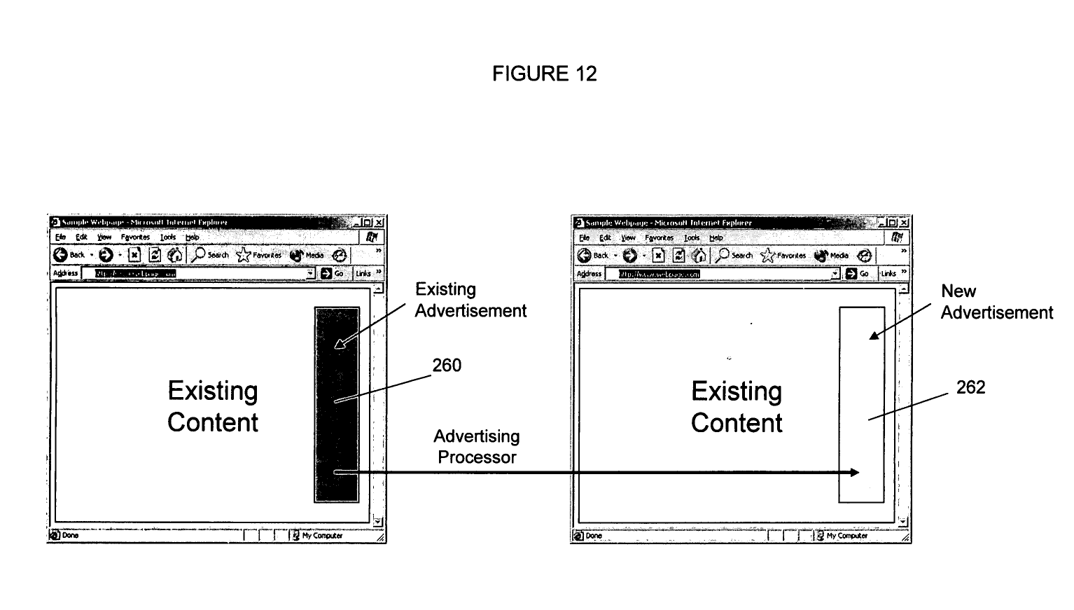

In the case of advertising substitution, the advertising processor substitutes new advertising into the data in place of existing advertising based upon the rules provided by the registrar. This is illustrated in FIG. 12, which shows existing advertising 260 being replaced by new advertising 262 in a browser web page. When the rules specify substitution of advertising, the advertising processor returns the requested data from the content provider to the user after first stripping out existing advertising and replacing it with the new advertising. The advertising processor may determine the location of existing advertising on a web page by analyzing the data contained in a web page, for example, to identify the footprint of an advertisement. Typical advertising footprints may include, for example, content that contains a piece of text or software code used by an advertiser, such as the Javascript advertisement insertion code used by Google. Advertising footprints may further be identified by content loaded directly or indirectly from the URL of a known advertiser, content of a certain fixed width or height and location, content that contains key words or graphical elements identifying the source of the content as, for example, the text stream “Ads by Google”, or content that can be identified by pattern matching or heuristic algorithms. Once the existing advertising has been identified, the advertising processor may replace the advertising with one of the advertisements in the registrar's advertising database using the advertising rules specified in the database.

In an alternative embodiment of the invention, instead of replacing existing advertising content in the data content provided to a user from a content provider in response to a data request, placeholders may be left in the data content into which selected advertising content may be inserted. This could be accomplished, for example, by also registering content providers as network entities, and predefining the placeholders to have a predefined size, location and format. The registrar may then insert selected localized or personalized advertising content into the data content provided to a user. Content providers may receive incentives, such as a share in the advertising revenue from advertisers whose advertising is inserted into their content, in the same way as other network entities.

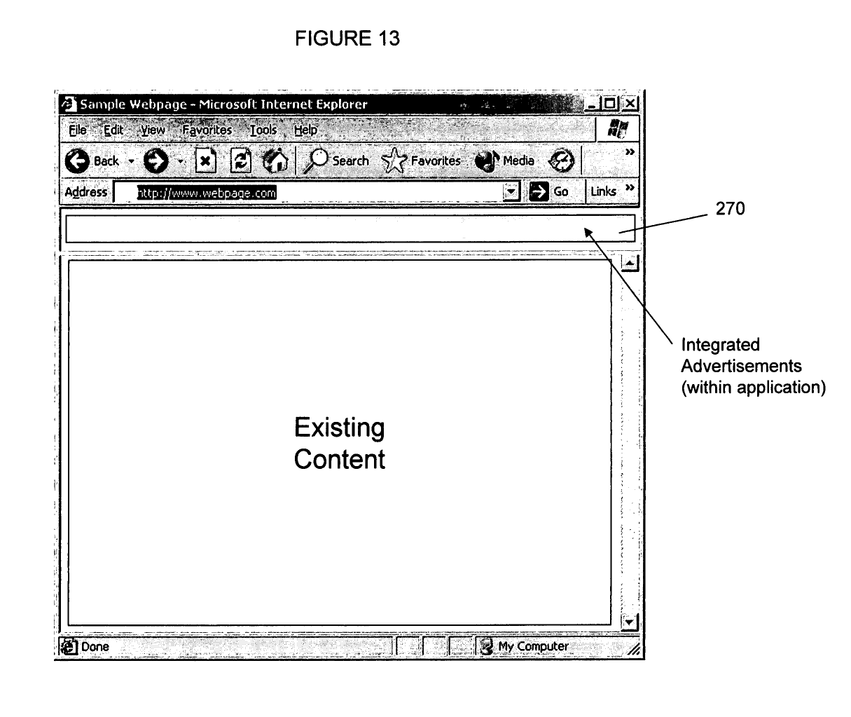

Instead of inserting advertising into content or substituting new advertising for existing advertising, the advertising may be integrated into an application. This is illustrated in FIG. 13, which shows an example of a web page displayed on a browser with integrated advertising inserted by the advertising processor into a designated area of the application, such as an area 270. For integrated advertising, the advertising processor may format and insert the advertising into the application when sending the requested data to the application. This is illustrated in FIG. 10. Rather than combining the requested data and the advertising supplied to the user application, the advertisement may be provided separately to a visible client application window 272, such as a web browser plug-in.

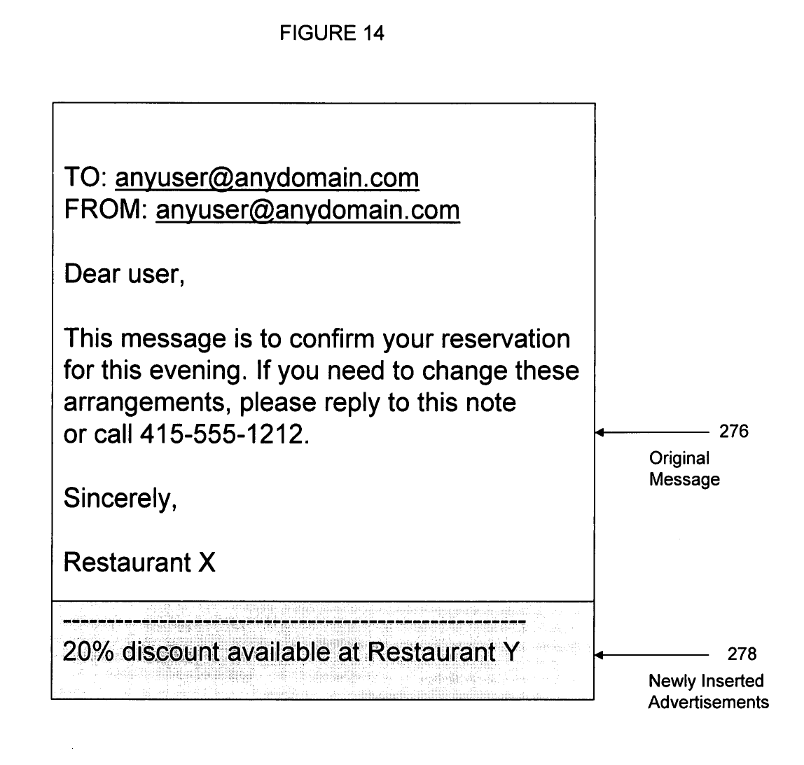

Finally, FIG. 14 illustrates another example of inserted advertising, where the advertising is inserted into a predetermined location 278 of an electronic mail message 276. Electronic mail servers typically use a POP3 or IMAP protocol. These protocols are readily decoded, and advertising or other content may be easily inserted into the bodies of the email messages at desired positions. Alternatively, other separate email messages containing the advertising may be sent to the user.

From the foregoing, it may be appreciated that the invention provides new and innovative business models and methods based upon shared advertising revenue for monetizing networks, particularly wireless networks, which provide incentives for expanding network infrastructure and membership, and which enable presentation of advertising to a user that is localized and/or personalized to the user according to predetermined criteria established by advertisers.

Although the invention has been described with reference to particular preferred embodiments, it will be appreciated that changes to these embodiments may be made with out departing from the principles and the spirit of the invention, the scope of which is defined by the appended claims.

1. A method of operating a network which includes providers of access points by which users access the network, and advertisers with associated advertising content, the method comprising:
registering providers and locations of associated access points of each of said providers;
registering users, including collecting for each user associated user information;
registering advertisers including storing associated advertising content and rules for presenting the advertising content;
presenting advertising content targeted to a user accessing the network by an access point, the advertising content being selected from one or more advertisers based upon said rules; and
sharing advertising revenue from said one or more advertisers of the targeted advertising content with a provider of said access point.

2. The method of claim 1, wherein said presenting targeted advertising content comprises localizing advertising to an access device of the accessing user.

3. The method of claim 1, wherein said presenting targeted advertising content comprises localizing advertising to the accessing user based upon the location of the access point by which the user accesses the network.

4. The method of claim 3, wherein said location comprises a local commercial region in the vicinity of the location of the access point.

5. The method of claim 1, wherein said presenting targeted advertising content comprises personalizing said advertising content to the accessing user.

6. The method of claim 5, wherein said personalizing comprises selecting advertising content based upon the one or more of user information associated with the accessing user, a data request made by the accessing user, and information provided from a content provider in response to said data request.

7. The method of claim 1, wherein said rules comprise criteria for selecting advertising content based upon time of day.

8. The method of claim 1 further comprising providing incentives to network entities that refer new entities that are registered on the network.

9. The method of claim 8, wherein each entity is provided a unique referral code upon registration, and wherein the method further comprises identifying referring entities and tracking incentives using said referral codes.

10. The method of claim 8, wherein said incentives comprise a portion of advertising revenue received from advertisers.

11. The method of claim 1, wherein said registering users comprises providing a user upon registration with a unique token for accessing the network.

12. The method of claim 1, wherein said registering users comprises providing a user upon registration with client software that detects an access point of a registered provider in the vicinity of the user and automatically configures the user for connection to the detected access point.

13. The method of claim 12, wherein said client software presents said advertising content to the user according to the associated rules of said advertising content.

14. The method of claim 1, wherein said presenting of advertising content comprises inserting said advertising content into information provided to the user by a content provider on said network.

15. The method of claim 14, where said inserting comprises substituting said advertising content for existing advertising in the information provided from said content provider.

16. A method of operating a network which includes providers of access points having predetermined locations by which users access the network, and advertisers with associated advertising content, the method comprising:
presenting to a user accessing the network by an access point selected advertising content from one or more of said advertisers based upon associated rules for presenting said advertising content; and
sharing advertising revenue from said one or more advertisers with the provider of said access point.

17. The method of claim 16, wherein said presenting selected advertising content comprises localizing the advertising content to the accessing user.

18. The method of claim 16, wherein said presenting selected advertising content comprises localizing the advertising content to said access point.

19. The method of claim 16, wherein said presenting selected advertising content comprises personalizing the advertising content to the accessing user in accordance with said associated rules.

20. The method of claim 19, wherein said personalized advertising content is selected based upon one or more of user demographics of the accessing user, a data request made by the accessing user, and information provided from a content provider in response to said data request.

21. The method of claim 16, wherein said advertising content is selected based upon advertiser-specified criteria in said rules.

22. The method of claim 16 further comprising registering entities comprising said providers, users and advertisers on said network, and providing incentives to such entities for referring another entity for registration on said network.

23. The method of claim 22, wherein said registering comprises providing each of said registered entities with a unique referral code, and said providing incentives comprises identifying the referring entity and tracking incentives using such entity's referral code.

24. The method of claim 22, wherein said network is a wireless network, and said registering comprises collecting information on user and access point wireless equipment, and providing client software to users and providers to configure such equipment to facilitate user access.

25. The method of claim 16, wherein said presenting of advertising content comprises inserting said advertising content into information provided to the user by a content provider on said network.

26. The method of claim 25, where said inserting comprises substituting said advertising content for existing advertising in the information provided from said content provider.

27. A method of operating a network which includes a plurality of providers of wireless access points having predetermined locations by which users access the network, the method comprising:
detecting by a user an access point in range of the user;
determining by said user whether the detected access point is a registered access point and, if so, automatically connecting the user to the network by the access point;
presenting to the user advertising content from one or more advertisers on the network based upon advertising rules associated with the advertising content, said rules specifying criteria for presenting advertising based upon one or more of localization and personalization information of the user; and
sharing advertising revenue from said one or more advertisers with the provider of said access point.

28. The method of claim 27, wherein said personalization information comprises one or more of demographic information about the user, information about a data request made by the user, and data provided in response to said data request.

29. The method of claim 27 further comprising registering entities comprising users, providers and advertisers on said network, providing each such entity a unique referral code, and using such referral code to identify and provide revenue to an entity referring an unregistered entity for registration on said network.

30. A method of operating a network which includes providers of access points by which users access the network, and advertisers with associated advertising content, the method comprising:
presenting to a user accessing the network selected advertising content from one or more of said advertisers, said advertising content being personalized to the user and being selected based upon associated rules for presenting said advertising content; and
sharing advertising revenue from said one or more advertisers with the provider of said access point by which the user accesses the network.

31. The method of claim 30, wherein said personalized advertising content is selected based upon one or more of user demographics, a user data request, and information provided in response to said data request.

32. The method of claim 30, wherein the user accesses the network by a voice-over-IP device, and the advertising content is presented as an audible or visible message to said device.

33. A method of operating a network which includes providers of access points by which users access the network, content providers of data content, and advertisers with associated advertising content, the method comprising:
transferring to a user requesting data content from a content provider on the network data content corresponding to the user's data request, and presenting to the user selected advertising content from one or more of said advertisers, said advertising content being selected based upon associated rules for presenting said advertising content and being presented to the user in the data content being transferred to the user; and
sharing advertising revenue from said one or more advertisers with a provider of an access point by which the user accesses the network.

34. The method of claim 33, wherein the advertising content is selected based upon the data content.

35. The method of claim 33, wherein said requested data content is transferred to the user as a data stream, and the selected advertising content is inserted into the data stream with the data content.
